(19) United States
(12) Patent Application Publication
(10) Pub. No.: US 2008/0243844 A1
(43) Pub. Date: Oct. 2, 2008

(54) INFORMATION PROCESSING APPARATUS AND INFORMATION PROCESSING METHOD

(75) Inventor: Shuji Ichikawa, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/046,853

(22) Filed: Mar. 12, 2008

(30) Foreign Application Priority Data
Mar. 29, 2007 (JP) 2007-089048

(51) Int. Cl. G06F 17/30

(52) U.S. Cl. 707/6; 707/E17.014

(57) ABSTRACT

Provided is an information search technique that can realize a short response time for a search request. To realize this object, a search client apparatus according to the invention is connected to a network system having a metadata search apparatus and a plurality of image search apparatuses, and comprises: a unit configured to transmit a search condition to the metadata search apparatus; a unit configured to group a plurality of image data, which has been obtained as a result of the search by the metadata search apparatus, in accordance with the number of image search apparatuses and allocate each of the image search apparatuses to each group; and a unit configured to transmit the search condition to each of the plurality of image search apparatuses and instruct to execute search processing on the allocated group of image data among the plurality of image data obtained by the search.

### BACKGROUND OF THE INVENTION

1. Field of the Invention

The present invention relates to an information search technique for searching a database.

2. Description of the Related Art

Conventionally various methods have been proposed for an information search in a large-scale database. For instance, Japanese Patent Laid-Open No. 5-334356 proposes a search apparatus which searches document files constituting a database for a document file including a particular word. This apparatus narrows down the search target in advance based on an index, then conducts the search.

Furthermore, Japanese Patent Laid-Open No. 4-281538 proposes a search method for dividing search conditions by the number of search apparatuses, allocating the divided search conditions to each of the search apparatuses, and conducting the search in parallel.

However, according to the search apparatus proposed by Japanese Patent Laid-Open No. 5-334356, when a document file including a particular word is searched from the narrowed-down search target, one search apparatus is used. Therefore, there is a limit to what the apparatus can do to reduce the response time for a search request.

Meanwhile, according to the search method proposed by Japanese Patent Laid-Open No. 4-281538, since a search is executed by plural search apparatuses, it is possible to some extent to reduce response time. However, when a search is conducted based on plural search conditions, there are cases that the search conditions cannot easily be divided by the number of search apparatuses.

### SUMMARY OF THE INVENTION

The present invention has been proposed in view of the above-described problems. The object of the present invention is to provide an information search technique that can make a search in response to a search request with short response time even in a case where a database scale is enlarged.

In order to attain the above object, an information processing apparatus according to the present invention has the following configuration. That is, an information processing apparatus comprises:

a receiving unit configured to receive first and second search conditions;

a first instruction unit configured to transmit the first search condition to a first search apparatus and instruct the first search apparatus to execute search processing on a plurality of data stored in a database based on the first search condition;

an allocation unit configured to decide a first search result, obtained by the first search apparatus, as a search target and allocate the search target to a plurality of second search apparatuses;

a second instruction unit configured to transmit the second search condition to the plurality of second search apparatuses and instruct each of the second search apparatuses to execute search processing on the search target based on the second search condition; and

an acquisition unit configured to acquire a second search result obtained by the second search apparatus.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an overall configuration of a search network system, to which an information processing apparatus (search client apparatus 101) according to the first embodiment of the present invention is communicably connected;

FIG. 2 is a block diagram showing a hardware configuration of the search client apparatus 101;

FIG. 3 is a block diagram showing a configuration of functions which are achieved by respective apparatuses constituting the search network system;

FIG. 4 is an illustration showing as an example a search condition setting screen displayed on a display unit 205 of the search client apparatus 101;

FIG. 5 is a table shown as an example of a search apparatus list stored in RAM 203;

FIG. 6 is a table shown as an example of a temporary table recorded in a database apparatus 106;

FIG. 7 is a table shown as an example of an image search target list 315 stored in the RAM 203;

FIG. 8 is a table shown as an example of a temporary table 310 in which search results of the image search apparatuses 103 to 105 are reflected;

FIG. 9 is a flowchart describing a search control procedure executed in the search client apparatus 101;

FIG. 10 is a flowchart describing a search control procedure executed in a metadata search apparatus 102; and

FIG. 11 is a flowchart describing a search control procedure executed in the image search apparatuses 103 to 105.

### DESCRIPTION OF THE EMBODIMENTS

Preferred embodiments of the present invention will now be described in detail in accordance with the accompanying drawings.

The embodiments according to the present invention are first described in brief. First, an information processing apparatus according to each of the following embodiments is characterized by controlling two types of search apparatuses which are capable of searching a database. The first type of search apparatus is a metadata search apparatus provided to make a search for metadata, which describes image data stored in a database, based on an input search condition. The second type of search apparatus is an image search apparatus provided to make a search for image data stored in a database based on an input search condition.

Second, an information processing apparatus according to each of the following embodiments is characterized by controlling the search apparatuses in a manner that the metadata search apparatus, which processes a relatively small amount of processing load, narrows down search targets before the image search apparatus executes an image data search. By virtue of this feature, in a case of a large-scale database, since image data search targets can be narrowed down, it is possible to suppress the processing load imposed on the image search apparatus and realize short response time for a search request.

Third, an information processing apparatus according to each of the following embodiments is characterized in that, among the two types of search apparatuses, the image search apparatus for performing an image data search is configured in a way that it can be adapted to scale-out. Therefore, in a case where a database scale is enlarged, the number of image search apparatuses executing an image data search can be increased accordingly, making it possible to suppress an increased processing load of each image search apparatus. As a result, a search can be executed in response to a search request with short response time.

Each of the embodiments is now described.

### First Embodiment

### 1. Configuration of Search Network System

Firstly described are the overall configuration of a search network system, to which an information processing apparatus according to the first embodiment is communicably connected, and each of the apparatuses constituting the search network system.

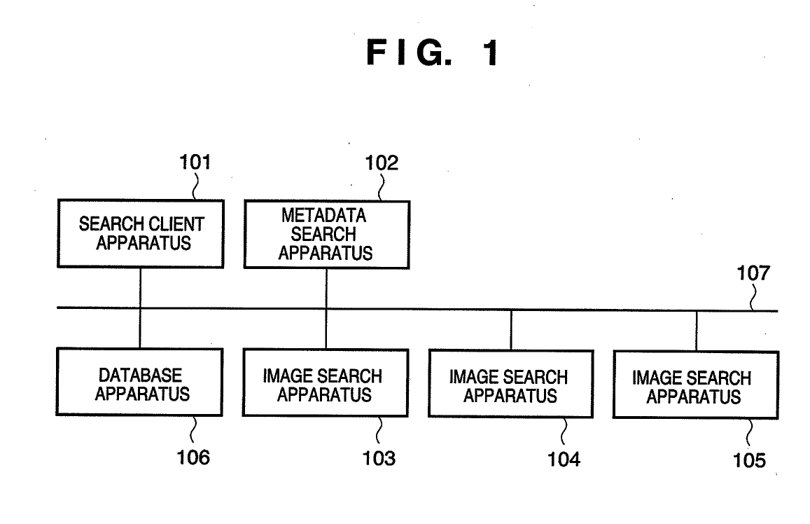

FIG. 1 is a block diagram showing an overall configuration of the search network system, to which the information processing apparatus (search client apparatus 101) according to the first embodiment is communicably connected. As shown in FIG. 1, the search network system comprises: a search client apparatus 101, a metadata search apparatus 102, image search apparatuses 103 to 105, and a database apparatus 106. These apparatuses are connected to the network 107 in a manner such that each of them is communicable. For the network 107, a LAN (local area network) such as an Ethernet, or a wide-area information communication network such as the Internet may be employed.

The search client apparatus 101 receives a search condition input from a user, and transmits various instructions to the metadata search apparatus 102 and image search apparatuses 103 to 105.

The metadata apparatus 102 and image search apparatuses 103 to 105 conduct a search in a database stored in the database apparatus 106 based on the instruction from the search client apparatus 101, and output search results.

Note that the metadata search apparatus 102 has functions for searching the database stored in the database apparatus 106 for metadata based on a search condition and outputting search results (image data ID). Meanwhile, image search apparatuses 103 to 105 have functions for searching the database in the database apparatus 106 for image data based on a search condition and outputting search results (image data ID and image search score).

The database apparatus 106 comprises a database which stores a plurality of image data and metadata describing the image data. The database apparatus 106 also stores a temporary table (details will be described later) which is generated in the search client apparatus 101 based on a search result output by the metadata search apparatus 102.

### 2. Hardware Configuration of Each Apparatus Constituting Search Network System

Described next is a hardware configuration of each of the apparatuses (101 to 106) constituting the search network system.

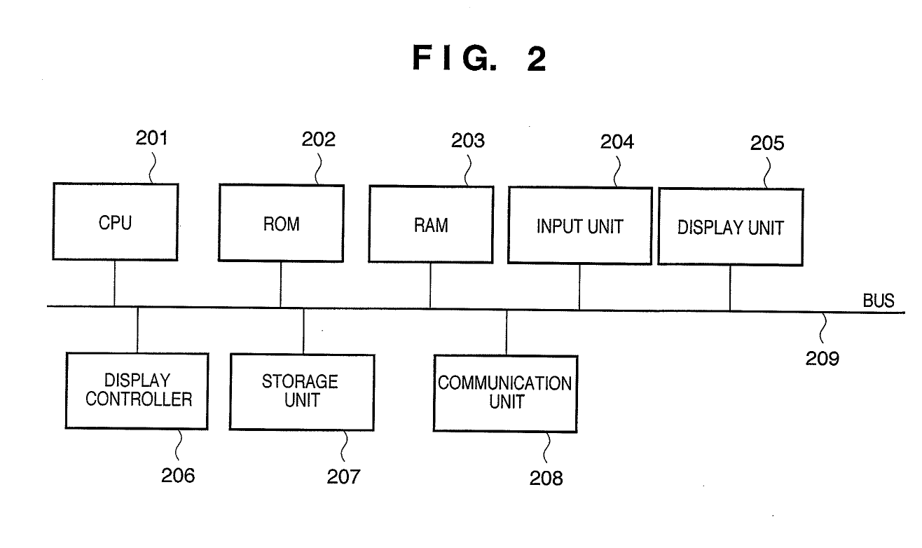

FIG. 2 is a block diagram showing a hardware configuration of the search client apparatus 101. Numeral 201 in FIG. 2 denotes a microprocessor CPU which executes calculation and logical determination for an information search, and controls each of the constituent elements connected to a bus 209.

Numeral 202 denotes fixed memory ROM (Read Only Memory) for storing control program codes such as a control program or the like executed by the present embodiment.

Numeral 203 denotes writable RAM (Random Access Memory) which is used for temporarily storing various data by each of the constituent elements.

Numeral 204 denotes an input unit. The input unit referred herein includes a keyboard having alphabet keys, letter symbol input keys for inputting punctuation or the like, a search key for instructing a search, and various function keys such as cursor motion keys for instructing cursor movement. Also the input unit 204 includes a mouse, stick pointer or the like serving as a pointing device which points a controllable position on a graphical user interface (GUI) screen and instructs selection of a function.

Numeral 205 denotes a display unit such as a CRT (Cathode-Ray Tube), a liquid crystal display or the like. A display unit controller 206 controls displaying of a cursor and display patterns having a dot configuration on the display unit.

Numeral 207 denotes a storage unit for storing a search-target list which will be described later, various data and the like. A hard disk, floppy disk (registered trademark), CD-ROM, DVD-ROM, memory card, magneto-optical disk and the like may be used for a storage medium storing these data and programs.

Numeral 208 denotes a communication unit, which is connected to a network such as an Ethernet (registered trademark), and serves to connect plural apparatuses in the network system shown in FIG. 1.

The information processing apparatus having the above-described constituent elements operates in accordance with various inputs from the input unit 204 or various inputs supplied from the communication unit 208 through the network 107. More specifically, when an input is supplied from the input unit 204 or communication unit 208, an interrupt signal is transmitted to the CPU 201, and the CPU 201 reads out various control signals stored in the storage unit 207. Various controls are executed in accordance with the control signals.

Further, the present invention can also be achieved by supplying a storage medium storing a program according to the present invention to a computer system or apparatus, reading the program codes stored in the storage medium by a computer of the system or apparatus, then executing the program.

Note that, although FIG. 2 is described as a hardware configuration of the search client apparatus 101, the metadata search apparatus 102, image search apparatuses 103 to 105, and database apparatus 106 basically have a similar hardware configuration.

### 3. Configuration of Functions Achieved by Apparatuses Constituting Search Network System

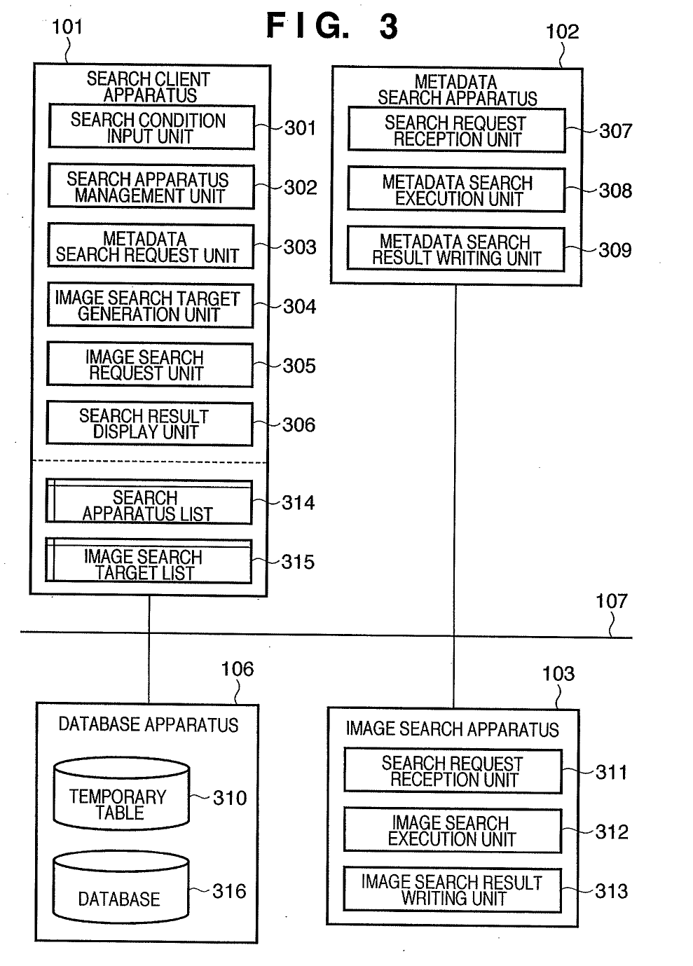

Described next in detail with reference to FIG. 3 is the configuration of functions achieved by respective apparatuses constituting the search network system.

FIG. 3 is a block diagram showing a configuration of functions which are achieved by respective apparatuses constituting the search network system. Since the image search apparatuses 103 to 105 have similar functions, FIG. 3 shows the image search apparatus 103 only and omits descriptions of the image search apparatuses 104 and 105.

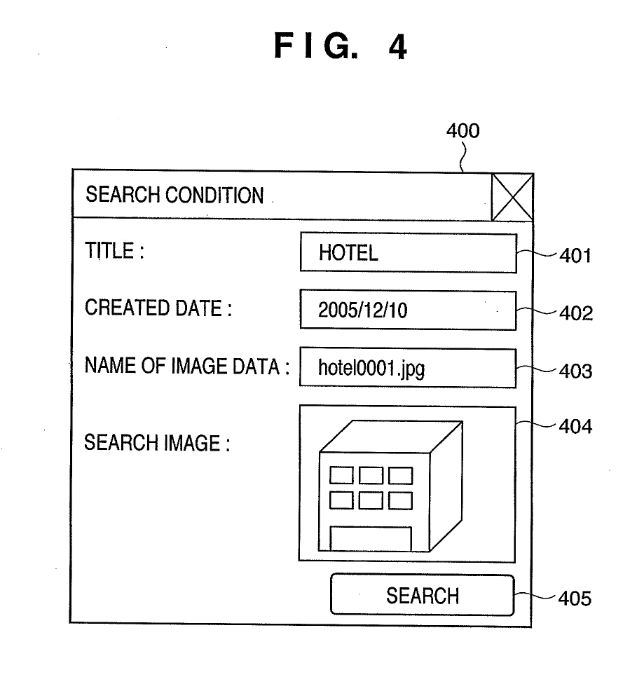

In describing the configuration of functions achieved by respective apparatuses, FIGS. 4 to 8 are also referred to as necessary.

3.1 Configuration of Functions Achieved by Search Client Apparatus

In the search client apparatus 101 in FIG. 3, numeral 301 denotes a search condition input unit. The search condition input unit 301 displays on the display unit 205 a search condition setting screen necessary for search condition inputs, and receives a search condition inputted by a user through the input unit 204.

Numeral 400 in FIG. 4 denotes an example of the search condition setting screen displayed on the display unit 205 of the search client apparatus 101.

As shown in FIG. 4, the search condition setting screen 400 has a title input field 401 for inputting a title, indicative of a search condition (metadata search condition) used for a search by the metadata search apparatus 102, and a creation date input field 402 for inputting a date of creation.

The screen 400 also has an image data name input field 403 for inputting a name of image data, indicative of a search condition (image search condition) used for a search by the image search apparatuses 103 to 105, and a thumbnail image display field 404 for displaying a thumbnail image having the input image data name. The screen 400 further has a search execution button 405 for instructing execution of the search. When the search execution button 405 is pressed, search control is executed by the metadata search apparatus 102 and image search apparatuses 103 to 105 based on the search conditions input in the title input field 401, creation date input field 402, and image data name input field 403.

Numeral 302 in FIG. 3 denotes a search apparatus management unit, which acquires IP addresses of the metadata search apparatus 102 and image search apparatuses 103 to 105 connected to the network 107, and stores the IP addresses as a search apparatus list 314 in the RAM 203. Based on the acquired IP addresses, the number of image search apparatuses is calculated and recorded in the search apparatus list 314.

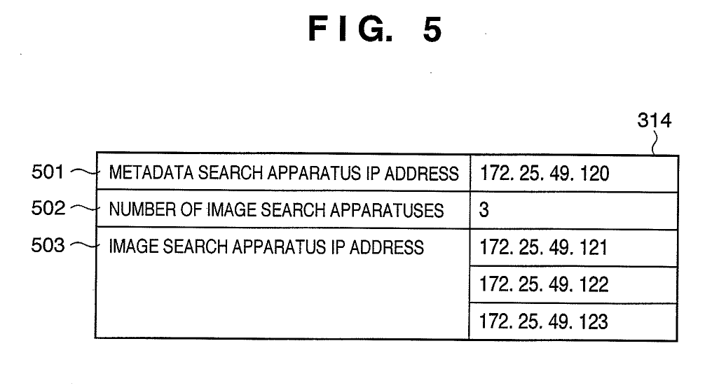

Numeral 314 in FIG. 5 denotes an example of the search apparatus list stored in the RAM 203. As shown in FIG. 5, the search apparatus list 314 has a storage area 501 for storing an IP address of the metadata search apparatus 102, a storage area 502 for storing the number of image search apparatuses connected to the network 107, and a storage area 503 for storing IP addresses of image search apparatuses connected to the network 107.

Numeral 303 in FIG. 3 denotes a metadata search request unit. The metadata search request unit 303 executes control for transmitting the search condition, received from the search condition input unit 301, as a search request to the metadata search apparatus 102 whose IP address is stored in the RAM 203 by the search apparatus management unit 302.

Numeral 304 denotes an image search target generation unit. The image search target generation unit 304 executes control for acquiring the number of image data, which is searched by the metadata search apparatus 102 and whose ID (image data ID) is recorded in a temporary table 310 which will be described later. Further, the unit 304 executes control for dividing the number of image data by the number of image search apparatuses (502) whose IP addresses are stored in the RAM 203 as the search apparatus list 314. Based on the result of the division, the unit 304 executes control for generating an image search target list 315 indicative of the search target to be allocated to each of the image search apparatuses, and storing the list in the RAM 203.

As described above, the image search target generation unit 304 serves as allocation unit to group the plurality of image data, obtained as a result of search by the metadata search apparatus, in accordance with the number of image search apparatuses, and to allocate the image search apparatus to each group.

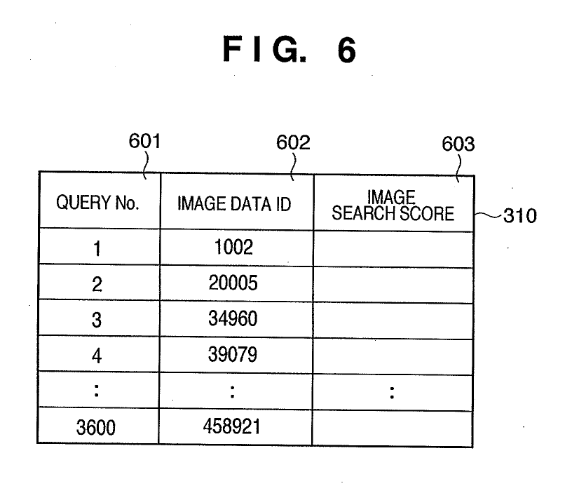

Numeral 310 in FIG. 6 denotes an example of the temporary table recorded in the database apparatus 106. As shown in FIG. 6, the temporary table 310 has an image data ID writing field 602 for recording an image data ID that specifies the image data searched by the metadata search apparatus 102. The table 310 also has a query number writing field 601 for recording serial numbers (query numbers) generated in association with each image data ID. Moreover, the table 310 has an image search score writing field 603 for recording an image search score in a case where a search by the image search apparatuses 103 to 105 is completed. The example in FIG. 6 shows that, as a result of the search by the metadata search apparatus 102, the total of 3600 image data, including image data having ID=1002 to image data having ID=458921, have been searched.

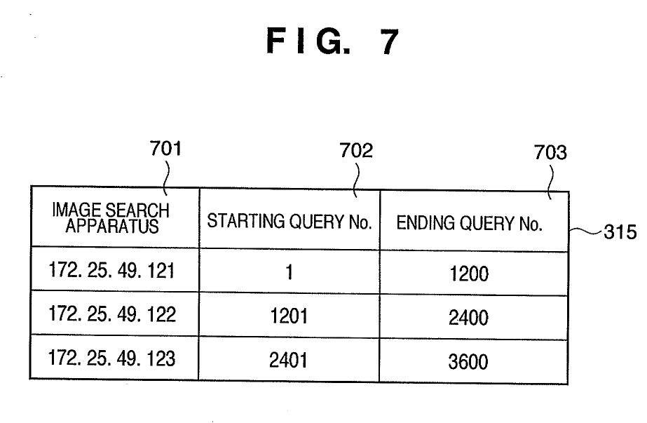

Numeral 315 in FIG. 7 denotes an example of the image search target list 315 stored in the RAM 203. As shown in FIG. 7, the image search target list 315 has a storage area 701 for storing IP addresses of the image search apparatuses. The list 315 also has a storage area 702 for storing the starting query number indicative of the beginning of image data targeted for the search by respective image search apparatuses. Moreover, the list 315 has a storage area 703 for storing the ending query number indicative of the very end of the image data targeted for the search by respective image search apparatuses.

The starting and ending query numbers stored in the storage areas 702 and 703 are associated with the query numbers in the temporary table 310. In the example in FIG. 6, query numbers 1 to 3600 are stored and there are three image search apparatuses. In other words, 3600/3=1200 image data are allocated to each of the image search apparatuses. More specifically, image data having query numbers 1 to 1200 are allocated to the image search apparatus having the IP address 172.25.49.121. Image data having query numbers 1201 to 2400 are allocated to the image search apparatus having the IP address 172.25.49.122. Image data having query numbers 2401 to 3600 are allocated to the image search apparatus having the IP address 172.25.49.123.

Note that each image search execution unit 312 of the image search apparatuses 103 to 105 can acquire an image data ID of the search target based on the starting and ending query numbers stored in the image search target list 315.

Numeral 305 in FIG. 3 denotes an image search request unit which transmits as a search request the search condition input in the search condition input unit 301 and the image search target list 315 to the image search apparatuses whose IP addresses are stored in the search apparatus list 314. In other words, the image search request unit 305 serves as output control unit that controls the image search apparatus to output a search result.

Assume that the starting and ending query numbers corresponding to each of the image search apparatuses are transmitted together to each of the image search apparatuses.

Numeral 306 denotes a search result display unit. Search results (that reflect search results obtained by the image search apparatuses 103 to 105) recorded in the temporary table 310 which is stored in the database apparatus 106 are displayed on the display unit 205 of the search client apparatus 101.

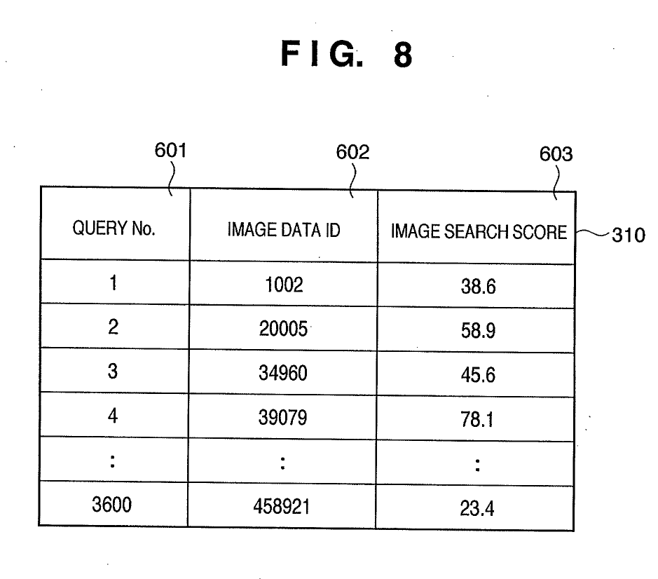

Numeral 310 in FIG. 8 denotes an example of the temporary table 310 in which search results obtained by the image search apparatuses 103 to 105 are reflected.

As shown in FIG. 8, as a result of the search by the image search apparatuses 103 to 105, image search scores of respective image data specified by image data IDs (identifiers) are recorded in the image search score writing field 603.

3.2 Configuration of Functions Achieved by Metadata Search Apparatus

In the metadata search apparatus 102 in FIG. 3, numeral 307 denotes a search request reception unit which receives a search request transmitted from the metadata search request unit 303 of the search client apparatus 101.

Numeral 308 denotes a metadata search execution unit which searches a database 316 in the database apparatus 106 for image data having metadata similar to the metadata search condition received by the search request reception unit 307.

Numeral 309 denotes a metadata search result writing unit which writes a search result (image data ID) obtained by the metadata search execution unit 308 in the temporary table 310 stored in the database apparatus 106 (see FIG. 6).

3.3 Configuration of Functions Achieved by Database Apparatus

In the database apparatus 106 in FIG. 3, the temporary table 310 stores search results of the metadata search apparatus 102 and search results of the image search apparatuses 103 to 105.

As the search results of the metadata search apparatus 102, an image data ID for specifying image data is recorded in the image data ID writing field 602 and a serial number (query No.) generated in association with each image data ID is recorded in the query number writing field 601 as shown in FIG. 6.

As the search results of the image search apparatuses 103 to 105, an image search score corresponding to each image data ID is recorded in the image search score writing field 603 as shown in FIG. 8.

3.4 Configuration of Functions Achieved by Image Search Apparatus

In the image search apparatus 103 in FIG. 3, numeral 311 denotes a search request reception unit which receives a search request transmitted from the image search request unit 305 of the search client apparatus 101.

Numeral 312 denotes an image search execution unit which conducts an image data search based on the image search condition and the starting and ending query numbers of the image search target list 315 which have been received by the search request reception unit 311.

More specifically, based on the starting and ending query numbers, an image data ID of the image data targeted for the search is obtained from the temporary table 310 stored in the database apparatus 106. Among the image data stored in the database 316, image data specified by the obtained image data ID are targeted for the search, and image data similar to the search condition is retrieved.

Numeral 313 denotes an image search result writing unit which writes an image search score in the temporary table 310 stored in the database apparatus 106 (see FIG. 8) based on the search result (image data ID and image search score) obtained by the image search execution unit 312.

### 4. Search Control Procedure in Each Apparatus Constituting Search Network System

Described next is a search control procedure executed in each of the apparatuses constituting the search network system.

4.1 Search Control Procedure in Search Client Apparatus 101

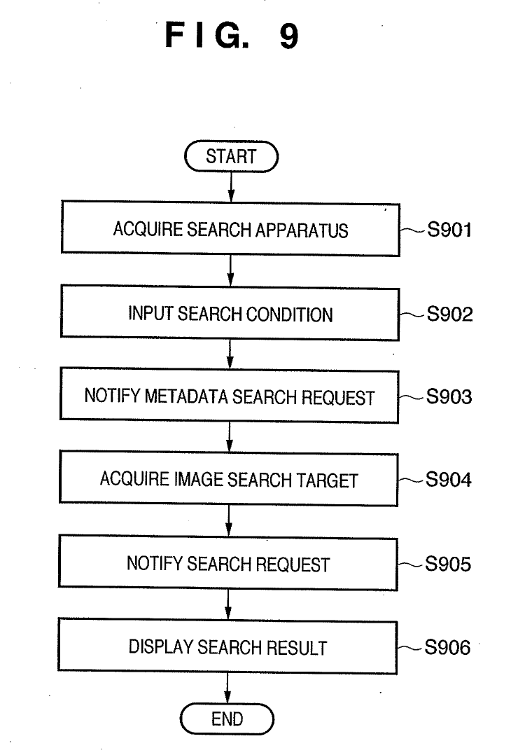

FIG. 9 is a flowchart describing a search control procedure executed in the search client apparatus 101.

In step S901, the search apparatus list 314 which is stored in the RAM 203 is updated by the search apparatus management unit 302. More specifically, the search apparatus management unit 302 acquires IP addresses of the metadata search apparatus 102 and image search apparatuses 103 to 105 that are connected to the network 107. The acquired IP addresses of respective search apparatuses and the number of image search apparatuses are stored in the search apparatus list 314.

In step S902, the search condition setting screen 400 is displayed on the display unit 205, and a search condition input is received from a user. Then, the control proceeds to step S903.

In step S903, the metadata search condition for conducting a search by the metadata search apparatus 102 is obtained from the search condition which has been input in step S902, and the IP address of the metadata search apparatus 102 is acquired from the search apparatus list 314. The metadata search condition is transmitted as a search request to the metadata search apparatus 102, and the control proceeds to step S904.

In step S904, image data to be targeted for the search by the image search apparatus is determined. More specifically, the number of image data is acquired from the search result of the metadata search apparatus 102, which has been recorded in the temporary table 310 by the metadata search result writing unit 309 of the metadata search apparatus 102.

Next, the number of image search apparatuses connected to the network 107 is read out of the storage area 502 of the search apparatus list 314 that has been stored in the RAM 203 by the search apparatus management unit 302.

Furthermore, the number of image data acquired in step S904 is divided by the read-out number of image search apparatuses, thereby obtaining the number of search target image data to be allocated to each image search apparatus.

From the beginning of the temporary table 310 in FIG. 6, an IP address of each image search apparatus in the search apparatus list 314 is sequentially allocated to the search target image data in the number calculated by the foregoing division, thereby generating the image search target list 315. As a result, search target image data which are to be searched by each image search apparatus is determined.

If there is a remainder when dividing the number of image data acquired in step S904 by the read-out number of image search apparatuses, the last image search apparatus in the storage area 503 is allocated to the image data corresponding to the remainder.

In step S905, IP addresses of the image search apparatuses to which the search request is to be transmitted are read out of the storage area 503 of the search apparatus list 314 that has been stored in the RAM 203 by the search apparatus management unit 302. The starting and ending query numbers of the image search target list 315 as well as the image search condition inputted in step S902 are transmitted as a search request to each of the image search apparatuses having the read IP addresses, and the control proceeds to step S906.

In step S906, the search result stored in the temporary table 310 of the database apparatus 106 is displayed on the display unit 205, and the control ends.

As described above, the search client apparatus 101 is configured in a way that the search target image data to be searched by each image search apparatus is decided in accordance with the number of image search apparatuses connected to the search network system (in other words, it is adaptable to scale-out). Therefore, in a case where the database scale is enlarged, the number of image search apparatuses can easily be increased.

4.2 Search Control Procedure in Metadata Search Apparatus 102

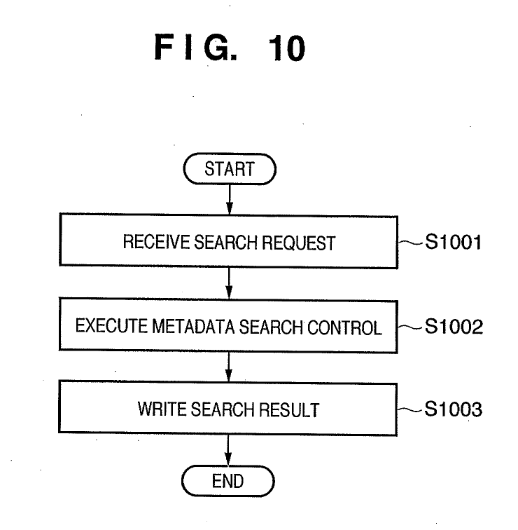

FIG. 10 is a flowchart describing a search control procedure executed in the metadata search apparatus 102.

In step S1001, a search request transmitted from the metadata search request unit 303 of the search client apparatus 101 is received by the search request reception unit 307. When the search request reception unit 307 receives the search request, the control proceeds to step S1002.

In step S1002, the metadata search execution unit 308 executes metadata search control based on the metadata search condition transmitted from the metadata search request unit 303 of the search client apparatus 101. Then the control proceeds to step S1003.

In step S1003, an image data ID specifying the image data which has been obtained as a result of search control in step S1002 is recorded in the temporary table 310 of the database apparatus 106.

4.3 Search Control Procedure in Image Search Apparatuses 103 to 105

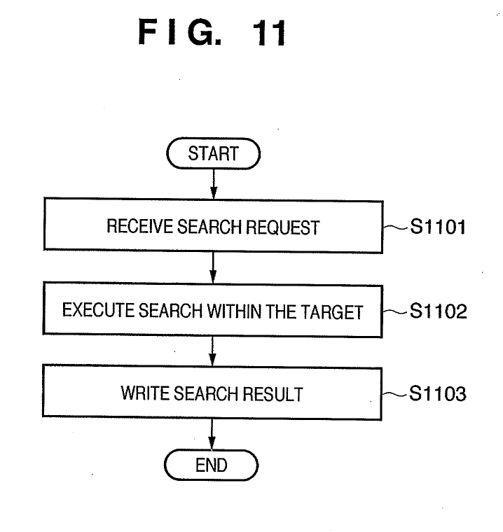

FIG. 11 is a flowchart describing a search control procedure executed in the image search apparatuses 103 to 105.

In step S1101, a search request transmitted from the image search request unit 305 of the search client apparatus 101 is received by the search request reception unit 311. When the search request reception unit 311 receives the search request, the control proceeds to step S1102.

In step S1102, the image search execution unit 312 executes image search control based on the image search condition transmitted from the image search request unit 305 of the search client apparatus 101 and the starting and ending query numbers which obtain the search target image data.

In step S1103, an image search score of each image data obtained as a result of image search control in step S1102 is recorded in the temporary table 310.

As is apparent from the above description, the information processing apparatus according to the present embodiment controls two types of search apparatuses (metadata search apparatus and image search apparatus) which can conduct a database search. Search targets are narrowed down by the metadata search apparatus first, then image data search is executed by the image search apparatus.

By virtue of this feature, even in a case where a database has a large scale, it is possible to narrow down image data search targets and reduce the processing load imposed on the image search apparatus.

Furthermore, according to the information processing apparatus of the present embodiment, the image search apparatus, among the two types of search apparatuses, is configured in a way that it can be adapted to scale-out. By virtue of this configuration, the number of image search apparatuses for conducting an image data search can easily be increased in accordance with an enlarged database scale, making it possible to suppress an increased processing load imposed on each image search apparatus. As a result, response time of a search request can be reduced.

### Second Embodiment

The above-described first embodiment obtains the number of search target image data to be allocated to each image search apparatus in accordance with the number calculated by dividing the number of image data acquired based on the search results of the metadata search apparatus 102 by the number of image search apparatuses. In other words, the search target image data is equally allocated regardless of the processing capability of each image search apparatus.

However, the present invention is not limited to this, and may be configured in a way that the number of search target image data to be allocated to each image search apparatus is changed in accordance with the processing capability of each image search apparatus so as to achieve substantially equal processing time of respective image search apparatuses. The processing capability of each image search apparatus may be digitalized in advance and stored.

Furthermore, although the above-described first embodiment inputs a title and created date as a metadata search condition, the present invention is not limited to this, and may be configured in a way that other metadata can be input.

Moreover, although the above-described first embodiment has described the search client apparatus 101, metadata search apparatus 102, and image search apparatuses 103 to 105 as separate apparatuses, the present invention is not limited to this and may be realized by an integrated apparatus.

### Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a computer system or apparatus with a storage medium, storing program codes of software realizing the above-described functions of the embodiments. In this case, the above-described functions are achieved by reading and executing the program codes stored in the storage medium by a computer (CPU or MPU) of the computer system or apparatus. Note that, in this case, the storage medium storing the program codes constitutes the present invention.

The storage medium, such as a floppy (registered trademark) disk, hard disk, optical disk, magneto-optical disk, CD-ROM, CD-R, magnetic tape, non-volatile memory card, and ROM can be used for providing the program codes.

Furthermore, the invention is not limited to the case where aforesaid functions of the above embodiments are realized by executing the program codes which are read by a computer. The present invention also includes a case where, for instance, an OS (operating system) or the like working on the computer performs part or the entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, the functions according to the above embodiments are realized. More specifically, the invention includes a case where a CPU or the like contained in the function expansion card or unit performs part or the entire processes in accordance with designations of the program codes and realizes the functions according to the above embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Application No. 2007-089048 filed on Mar. 29, 2007, which is hereby incorporated by reference herein in its entirety.

What is claimed is:

1. An information processing apparatus comprising:
a receiving unit configured to receive first and second search conditions;
a first instruction unit configured to transmit the first search condition to a first search apparatus and instruct the first search apparatus to execute search processing on a plurality of data stored in a database based on the first search condition;
an allocation unit configured to decide a first search result, obtained by the first search apparatus, as a search target and allocate the search target to a plurality of second search apparatuses;
a second instruction unit configured to transmit the second search condition to the plurality of second search apparatuses and instruct each of the second search apparatuses to execute search processing on the search target based on the second search condition; and
an acquisition unit configured to acquire a second search result obtained by the second search apparatus.

2. The information processing apparatus according to claim 1, further comprising a saving unit configured to acquire and save device information on each of the plurality of second search apparatuses,
wherein said allocation unit allocates the first search result to the plurality of second search apparatuses based on the device information.

3. The information processing apparatus according to claim 2, wherein said allocation unit determines the number of second search apparatuses based on the device information and allocates substantially a same number of first search result to each of the plurality of second search apparatuses.

4. The information processing apparatus according to claim 2, wherein said allocation unit determines processing capability of the second search apparatuses based on the device information and allocates the first search result in a way that each of the second search apparatuses achieves substantially equal processing time.

5. The information processing apparatus according to claim 3, wherein said allocation unit allocates the first search result to each of the second search apparatuses by associating the device information with an identifier which specifies each data of the first search result.

6. The information processing apparatus according to claim 5, wherein said data is image data,
said first search condition is a condition for conducting a metadata search, and
said second search condition is a condition for conducting an image data search.

7. An information processing method comprising the steps of:
receiving first and second search conditions;
transmitting the first search condition to a first search apparatus and instructing the first search apparatus to execute search processing on a plurality of data stored in a database based on the first search condition;
deciding a first search result, obtained by the first search apparatus, as a search target and allocating the search target to a plurality of second search apparatuses;
transmitting the second search condition to the plurality of second search apparatuses and instructing each of the second search apparatuses to execute search processing on the search target based on the second search condition; and
acquiring a second search result obtained by the second search apparatus.

8. A computer-readable storage medium which stores a program for causing a computer to execute the information processing method described in claim 7.
